(19) United States
(12) Patent Application Publication
(10) Pub. No.: US 2012/0068513 A1
(43) Pub. Date: Mar. 22, 2012

(54) UNLOCKING DEVICE

(75) Inventors: Borris Ilse, Mainz (DE); Boris Jacob, Wiesbaden (DE); Bertrand Bach, Wiesbaden (DE); Ralf Wilfert, Buetelborn (DE); Woon Han Lee, Wiesbaden (DE)

(73) Assignee: GM GLOBAL TECHNOLOGY OPERATIONS LLC, Detroit, MI (US)

(21) Appl. No.: 13/237,599

(22) Filed: Sep. 20, 2011

(30) Foreign Application Priority Data
Sep. 22, 2010 (DE) 102010046296.9

(51) Int. Cl. B60N 2/20; B60N 2/44

(52) U.S. Cl. 297/353; 297/463.1

(57) ABSTRACT

An unlocking device is provided for a vehicle seat of a motor vehicle, particularly for a vehicle seat with a foldable backrest, that includes, but is not limited to a basic element arranged on the backrest of the vehicle seat with a longitudinal axis, an unlocking element rotatable connected about a swivel axis to the basic element, as well as a belt guide. The swivel axis is substantially arranged perpendicularly to the longitudinal axis of the basic element and the swivel axis is arranged in a plane of the backrest, and the belt guide configured in the form of an open profile. Through the unlocking element an improved entering is made possible.

### CROSS-REFERENCE TO RELATED APPLICATION

This application claims priority to German Patent Application No. 102010046296.9, filed Sep. 22, 2010, which is incorporated herein by reference in its entirety.

### TECHNICAL FIELD

The technical field relates to an unlocking device for a vehicle seat of a motor vehicle.

### BACKGROUND

From DE 198 38 930 C1 a belt arrangement for a seat of locomotion means, more preferably of a motor vehicle, with a shoulder belt part which in the region of a backrest of the seat provided with a folding mechanism is placed through a slit guide, is known. The slit guide for the belt guidance in this case is at least partially formed through an actuation member for an unlocking device of the folding mechanism of the backrest. Disadvantageous in this case is that through the belt the unlocking of the folding mechanism and the folding of the backrest of the seat is rendered more difficult, as a result of which entering is made more difficult.

It is at least one object is to make available a vehicle seat that allows an improved entry. In addition, other objects, desirable features and characteristics will become apparent from the subsequent summary and detailed description, and the appended claims, taken in conjunction with the accompanying drawings and this background.

### SUMMARY

An unlocking device for a vehicle seat of a motor vehicle, particularly for a vehicle seat with a foldable backrest, comprising a basic element arranged on the backrest of the vehicle seat with a longitudinal axis, an unlocking element, wherein the unlocking element is connected to the basic element rotatable about a swivel axis, as well as a belt guide. According to the invention, the swivel axis is substantially perpendicular to the longitudinal axis of the basic element and arranged in a plane of the backrest, and the belt guide is configured in the shape of an open profile.

The unlocking element can be arranged on the backrest both of a front seat as well as a backseat of a vehicle. The vehicle seat in this case can comprise a backrest that is foldable connected to a seating and/or a repositioning device coupled to an unlocking device of the backrest, a so-called easy-entry function. The unlocking element comprises a basic element, which in a vertical direction can be arranged along a side cheek of the backrest of the vehicle seat. The basic element can be designed in the shape of a planar surface or curved, for example matched to a contour of the backrest. The basic element comprises a longitudinal axis which is substantially arranged vertically parallel to the side cheek of the backrest. Here, the basic element can be designed slim along its longitudinal axis, in vertical direction to the backrest, as a result of which an assembly of the unlocking element for example on the backrest of a sports seat becomes possible, which only has a minor thickness. An unlocking element for unlocking the backrest of the vehicle seat connected to the basic element is rotatable mounted about a swivel axis. The unlocking element can be designed in such a manner that an actuation with one hand is made possible, for example through the embodiment of a lever. The unlocking element can be arranged on an upper end of the basic element facing the upper edge of the backrest. The unlocking element, covering a part area of the basic element, can end flush with the outer contour of the basic element. The swivel axis can be arranged substantially perpendicularly to the longitudinal axis of the basic element and/or the surface of the basic element, and in a plane of the backrest of the vehicle seat. The plane of the backrest in this case can be arranged substantially parallel to the surface of the backrest which at the back supports a person seated on the vehicle seat. The unlocking element can be swiveled or rotated about the swivel axis from a first position, in which the locking device is closed, into a second position, in which the locking device is unlocked. The swiveling from the first position into the second position in this case can take place in direction of a front side of the seat, which corresponds to the direction in which for example the folding movement of the unlocked backrest takes place. Here, the swiveling from the first position into the second position can substantially take place parallel to the surface of the basic element. Here, the surface of the basic element can be configured as a guide and/or a support of the unlocking element. The unlocking element comprises a belt guide, which makes possible a guidance for example of a belt worn for example by the driver of the vehicle. The belt guide is at least partially formed through the basic element and the unlocking element and is configured in the shape of an open profile, wherein the profile is opened on a side facing away from the backrest. In an operating state, in which the belt for example has been buckled up by a driver the belt can rest on the unlocking device without being enclosed, wherein the belt can be guided through the profile. The profile can for example be designed in L-shaped. The L-profile is formed through the surface of the basic element and for example of a first guide edge, which can be formed on a side of the unlocking element facing the surface of the basic element.

The advantage of the unlocking element lies in that through the slim configuration of the unlocking element in vertical direction an installation in seats with only little installation space, for example in sportive seat models with an integrated headrest as well as side cheeks is made possible, which usually only have a small thickness of the backrest and/or of the side cheeks. Through the belt guide integrated in the unlocking device a slipping of a belt for example worn by the driver can be avoided, as a result of which the belt can be guided in a controlled manner over the side cheek of the backrest and the safety of the driver be thus increased. It is particularly advantageous that through the configuration of the unlocking device the unlocking for example of the backrest of the vehicle seat can be effected by swiveling the unlocking element in the direction of the folding movement of the backrest of the vehicle seat, so that an unlocking movement is substantially directed in the same direction as a folding movement of the backrest and/or a repositioning movement of the vehicle seat. Through this a particularly ergonomical force flow is achieved, which guarantees a one-hand operation of the unlocking device without additional operations and without interfering belt, as a result of which an improved entry is made possible.

In an embodiment of the unlocking device the unlocking element comprises an actuating element. The actuating element is formed in the shape of a loop. The actuating element can be designed narrower than the unlocking element. In a locked position of the backrest, for example while the vehicle is being driven, the actuating element can be substantially rest on the basic element parallel to the longitudinal axis of the basic element. Through the design of an actuating element in the form of a pulling element on the unlocking element, particularly in the form of a loop, the transmission of a force for actuating the unlocking element and for folding the backrests and/or the repositioning of the vehicle seat to the unlocking element can be improved.

In another embodiment of the unlocking device the actuating element can be produced from a textile fabric and/or leather. The actuating element can be produced of a light-conducting and/or light-permeable, transparent material. Through the usage of a textile fabric and/or of leather, for example in the form of a textile loop or a leather loop, the grip strength of the actuating element can be improved, as a result of which an improved force transmission can be made possible.

Particularly preferably the actuating element can be fixed on the basic element by means of a magnetic force. The actuating element can comprise a body, particularly a magnetic body, which adheres to a corresponding non-magnetic or magnetic body on or in the basic element. The actuating element can comprise a magnetic body, for example a magnet, which can directly adhere to the basic element, particularly of a magnetizable metal basic element. Through the use of a magnetic force for fixing the actuating element on the basic element a self-centering fixing of the actuating element is achieved.

In another embodiment the unlocking device comprises an illumination device. The illumination device can be designed in the form of a light-emitting diode, an LED. The illumination device can for example be arranged in the basic element or the unlocking element. The illumination device can also be arranged concealed from the outside in the unlocking device, wherein light of the illumination device for example can be coupled in an actuating element of a suitable light-conducting material. Through the illumination the actuating element, particularly in the dark, can be detected more easily, as a result of which the operation of the unlocking device can be facilitated particularly in the dark.

Particularly preferably the basic element comprises a guide element. The guide element can be arranged on an end of the basic element located opposite the unlocking element. The guide element can comprise a second guide edge in the form of a step on its inner side facing the unlocking element. In conjunction with the first guide edge on the inner side of the unlocking element an open, flat, U-shaped profile for the belt guidance can be formed through the second guide edge, as a result of which the belt guidance can be improved. A vehicle seat is provided that comprises at least one unlocking device. The unlocking device can be embodied and further developed as described above.

### BRIEF DESCRIPTION OF THE DRAWINGS

The present invention will hereinafter be described in conjunction with the following drawing figures, wherein like numerals denote like elements, and:

FIG. 1 is a schematic view of an unlocking device according to an embodiment in a locked position;

FIG. 2 is a schematic view of an unlocking device in an unlocked position;

FIG. 3 is a vehicle seat with an unlocking device; and

FIG. 4 is a vehicle seat with an unlocking device and a guided belt.

### DETAILED DESCRIPTION

The following detailed description is merely exemplary in nature and is not intended to limit application and uses. Furthermore, there is no intention to be bound by any theory presented in the preceding background or summary or the following detailed description.

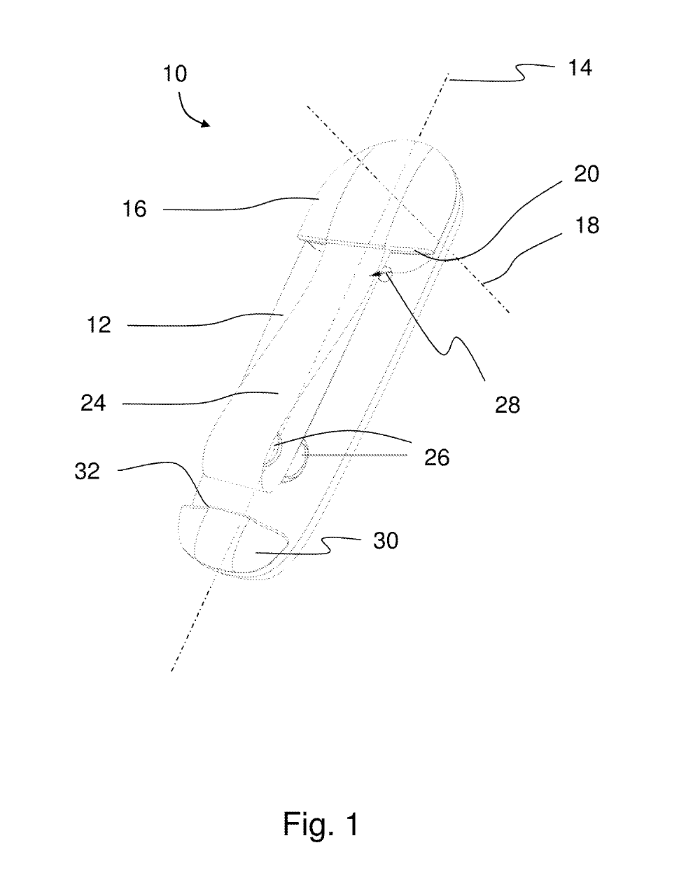

The unlocking device 10 shown in FIG. 1 comprises a narrow, longitudinally designed flat baseplate 12 with a longitudinal axis 14. On a first end of the baseplate 12 an unlocking element is arranged, wherein the unlocking element 16 is rotatable mounted about a swivel axis 18. The unlocking element 16 is shown in a first, locked position. The unlocking element 16 on its outer sides ends flush with the baseplate 12. On its inner side the unlocking element 16 comprises a first guide edge 20 for guiding a belt 22 (not shown). The unlocking element 16 comprises an actuating element 24, which is designed in the shape of a loop. The actuating element 24 is partially worked into the unlocking element 16 flush with the surface, wherein the first guide edge 20 formed step-shaped is retained. In order to hold the actuating element 24 in the locked position a magnetic fixing 26 is provided, which is arranged both on the actuating element 24 as well as in the baseplate 12. An illumination device 28 is sunk into the baseplate 12 which can light onto or back-light the actuating element 24 and can fulfill an indicating function to the unlocking element 16. On an end located opposite the unlocking element 16 the baseplate 12 comprises a guide element 30, which on its outer sides ends flush with the baseplate 12 and on its inner side comprises a second guide edge 32. The belt guide is formed through baseplate 12, the first guide edge 20 and the second guide edge 32 in the form of an open, flat, U-shaped profile. In this open profile a belt 22 can be located for guidance. The belt 22 in this case can rest on the baseplate 12 and/or the actuating element 24.

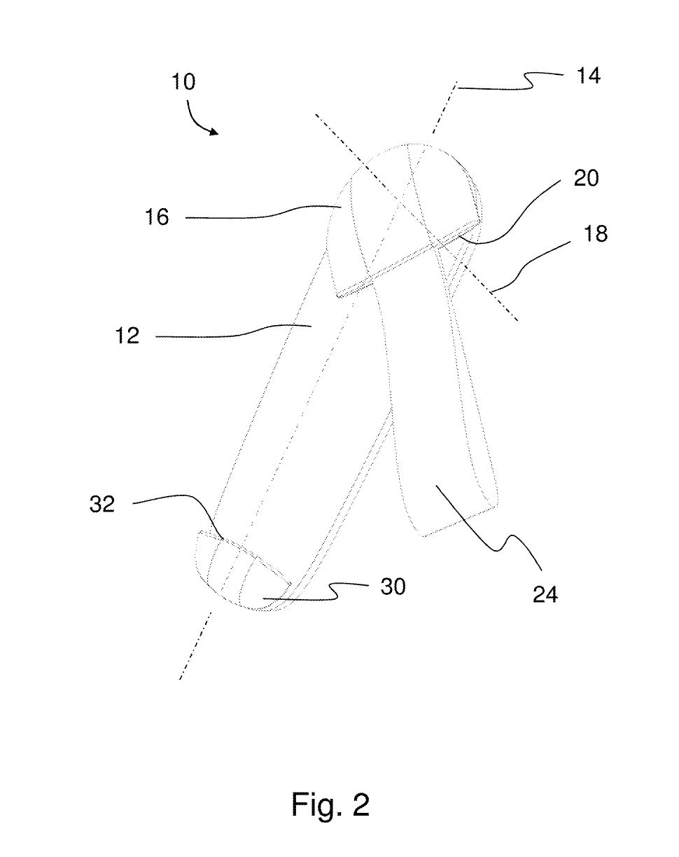

FIG. 2 shows the unlocking device 10 in an unlocked position. The unlocking element 16 is swiveled about the swivel axis 18 from the first, locked position into the second, unlocked position. The unlocking of a backrest 34 and/or an easy-entry function is effected by a forward pulling of the actuating element 24 in the direction of the front side of the vehicle seat, as a result of which a folding forward of the backrest 34 and/or a sliding forward of the vehicle seat, the so-called easy-entry function, is made possible.

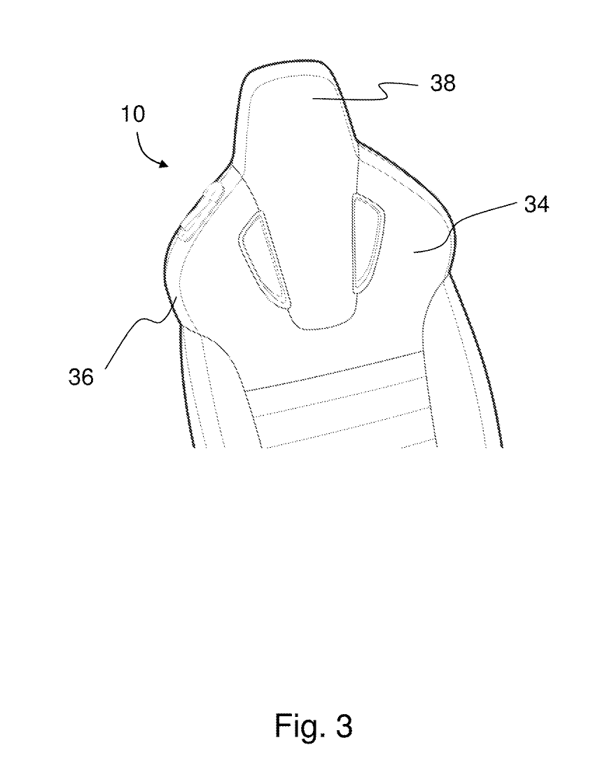

The backrest 34 (FIG. 3) of a sportive vehicle seat on a side cheek 36 next to a headrest 38 comprises an unlocking device 10. In the shown position the unlocking device 10 can be actuated by pulling the actuating element 24 forward in the folding direction of the backrest 34. The pulling direction for actuating the unlocking device 10 in this case corresponds to the direction in which the backrest 34 is to be folded and/or the vehicle seat is to slide. Consequently the actuation of the unlocking device 10 and a movement of the backrest 34 and/or of the vehicle seat can be effected without changing grips and in an ergonomically favorable direction.

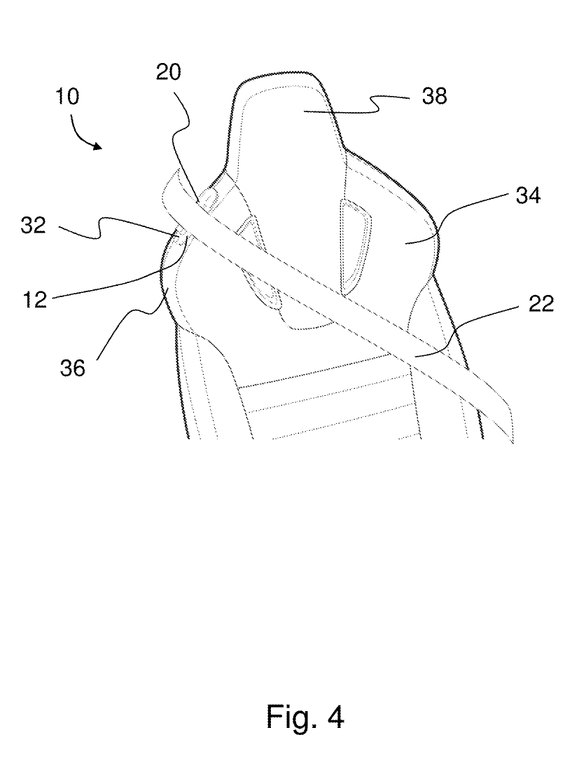

FIG. 4 shows the backrest 34 with an unlocking device 10 in an operating state, for example while the motor vehicle is being driven, with a belt 22 stretched over the vehicle seat of a driver who is not shown. The belt 22 rests on the actuating element 24 in the open, flat, U-shaped profile of the belt guide, which is formed through the baseplate 12, the first guide edge 20 and the second guide edge 32.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An unlocking device for a vehicle seat of a motor vehicle, comprising:
a basic element arranged on a backrest of the vehicle seat with a longitudinal axis;
an unlocking element rotatable connected about a swivel axis to the basic element; and
a belt guide comprising an open profile,
wherein the swivel axis is substantially arranged perpendicularly to the longitudinal axis of the basic element and the swivel axis is arranged in a plane of the backrest.

2. The unlocking device according to claim 1, wherein the backrest is a foldable backrest.

3. The unlocking device according to claim 1, wherein the unlocking element comprises an actuating element.

4. The unlocking device according to claim 3, wherein the actuating element is in a shape of a loop.

5. The unlocking device according to claim 3, wherein the actuating element is at least partially produced from a textile fabric.

6. The unlocking device according to claim 3, wherein the actuating element is at least partially produced from leather.

7. The unlocking device according to claim 3, wherein the actuating element is fixable to the basic element with a magnetic force.

8. The unlocking device according to claim 1, wherein the unlocking device comprises an illumination device.

9. The unlocking device according to claim 1, wherein the basic element comprises a guide element.

10. A vehicle seat, comprising:
a backrest;
a basic element arranged on the backrest with a longitudinal axis;
an unlocking element rotatable connected about a swivel axis to the basic element; and
a belt guide comprising an open profile,
wherein the swivel axis is substantially arranged perpendicularly to the longitudinal axis of the basic element and the swivel axis is arranged in a plane of the backrest.

11. The vehicle seat according to claim 10, wherein the backrest is a foldable backrest.

12. The vehicle seat according to claim 10, wherein the unlocking element comprises an actuating element.

13. The vehicle seat according to claim 12, wherein the actuating element is in a shape of a loop.

14. The vehicle seat according to claim 13, wherein the actuating element is at least partially produced from a textile fabric.

15. The vehicle seat according to claim 13, wherein the actuating element is at least partially produced from leather.

16. The vehicle seat according to claim 13, wherein the actuating element is fixable to the basic element with a magnetic force.

17. The vehicle seat according to claim 10, wherein the unlocking element comprises an illumination device.

18. The vehicle seat according to claim 10, wherein the basic element comprises a guide element.
